(19) United States
(12) Patent Application Publication
(10) Pub. No.: US 2018/0218122 A1
(43) Pub. Date: Aug. 2, 2018

(54) External Triggering of Geographically Focused Targeted Messaging and Related Massive Data Management

(71) Applicants: Erin DeRuggiero, Minneapolis, MN (US); Dustin Suchter, Arcadia, CA (US)

(72) Inventors: Erin DeRuggiero, Minneapolis, MN (US); Dustin Suchter, Arcadia, CA (US)

(21) Appl. No.: 15/816,381

(22) Filed: Nov. 17, 2017

Related U.S. Application Data
(60) Provisional application No. 62/453,871, filed on Feb. 2, 2017.

(51) Int. Cl. G06F 19/00; G06Q 30/02

(52) U.S. Cl. CPC G06F 19/327; G06Q 30/0259

(57) ABSTRACT

A system and method are presented that presents targeted messaging to recipient's devices. The system operates by providing a control system server containing message programming and a relational database. The system receives trigger data at the relational database as well recipient data. A recipient data source provides recipient data to the message programming. A messaging purchase interface is also provided, and is configured to provide the control system server with an ordered messaging program including business rules and message content. The system determines that a first trigger data item meets the business rules of the ordered message program and uses the business rules to identify a first subset of recipients to receive the ordered message content. The system then reviews and transmits that content to at least one digital device of at least one healthcare provider.

### CROSS-REFERENCE TO RELATED APPLICATIONS

The present application is a utility filing based on U.S. Provisional Patent Application No. 62/453,871, which was filed on Feb. 2, 2017, the entire contents of which are incorporated herein by reference.

### FIELD OF THE INVENTION

The present invention relates to the field of trigging targeted messaging or advertisements through the monitoring of external data feeds. More particularly, the present invention relates to an improved technique for the central reception of trigger data from a plurality of external sources, highly targeted messaging based on device identifiers and geographic locations being tied to received data triggers, and the management of the associated massive data.

### SUMMARY

The present invention monitors data feeds from a variety of sources. The data feeds are typically provided by external data providers in a variety of formats. To allow for efficient data reception of a large amount of data from a plurality of sources, the data feeds store on external data repositories accessible over a wide area network such as the Internet. Systems monitor the data repository for changes in the data, either through frequent polling of the data repositories from an ingestion server that pulls data from the repository, or through active listener logic located on the repository that pushes notification of new data out from the repository.

Data from multiple repositories is received by a computer system dedicated to ingesting the incoming data. This data ingestion system receives data from the repository and validates the consistency of the data against preset validation rules. Because the data was stored on the repository by a variety of data source providers each using their own format, the data ingestion system is also responsible for transforming the data to a single, pre-set format using pre-established data transformation rules. The data ingestion system submits the validated and transformed data as trigger data to a central control system that takes the form of a separate control system server.

The control system server places trigger data into a relational database. This database also contains information about potential recipients of targeted messages provided by the system. In one embodiment, the recipients are healthcare providers, and the database contains information about healthcare facilities (including the area of specialty for each facility and its geographic location), the healthcare providers that are registered as workers at those facilities, and healthcare providers who are physically present at those facilities. The control system server also receives orders for targeted messaging. The orders take the form of “programs” which include both business rules for establishing when a message is to be transmitted under the program and the content of the message itself. The control system contains programming logic that analyzes the trigger data to determine whether or not the business rules for a program have been met. If so, the recipient information is analyzed to determine potential recipients, and acceptable message locations are determined (such as through a white-list of acceptable placement locations).

The recipients (defined both through device identifiers and geographic location and/or proximity to a healthcare facility), the message content, and the message placement details are then submitted to a message placement server system. The message placement server system then monitors potential message placements among the recipient devices operating over a wide area network. Third party messaging coordinators (such as Google LLC of Menlo Park, Calif.) identify message placement opportunities. The message placement server system compares the opportunities against the data received from the central control server. If a match is found, an aggressive bid price is submitted for the placement of the message. If the bid is accepted, the message content is presented on the recipient device and information about the opportunity, the message, the recipient, and subsequent interaction is logged.

The message placement server systems are responsible for hundreds of millions of message placements, and are able to track impressions and message follow-through transactions. This massive amount of data is received from a plurality of message placement server systems by a data collection computer system. This data collection system validates the data and the submits the data to a data splitter. Because of the quantity of data involved, it is not practical to actively store all of the data for later retrieval using standard database backup routines. Instead, a copy of the data is split off and sent into a “cold storage” facility designed for long term, inexpensive, off-line data storage. The data splitter also sends the data into the control system server.

The control system server stores the incoming data in its big data system. The control system server in this case is operating as a reporting system to report out the messaging activity of the system customers that ordered the messaging programs. The details concerning the frequency and format for the reports is stored in connection with both the relational database (which contains information about the particular report) and a customer database (which contains information on how to deliver data to a particular customer). Using this information, the system identifies a subset of the massive amounts of data on the big data system that is relevant to a particular program needing a report and appropriately filters this data. The data is then formatted into a draft report. Quality assurance programming will then analyze the report to ensure that the report is in the proper format and contains actual, relevant data.

The completed report is then sent to a separate computer system, namely the high volume data output system. This system is responsible for placing the report on the appropriate data repository capable of handling very large quantities of information.

### BRIEF DESCRIPTION OF THE DRAWINGS

FIG. 1 is a schematic view of a first embodiment system that operates to submit targeted messaging based on content of live data feeds.

FIG. 2 is a schematic diagram of example data feed of data received from third party data providers such as may be provided for in the system of FIG. 1 focused on targeted messaging to health service providers.

FIG. 3 is a flow chart showing a method for submitting targeted messaging based on the content of live data feeds and triggering events such as is provided for by the system of FIG. 1.

FIG. 4 is a schematic view of the system of FIG. 1 illustrating the manner in which the system receives massive data from advertisement server systems and presents appropriate reports to users of the system.

FIG. 5 is a flow chart showing a method for receiving massive data from advertisement server systems and presenting reports to users in accordance with the system shown in FIG. 4.

### DETAILED DESCRIPTION

### System Overview

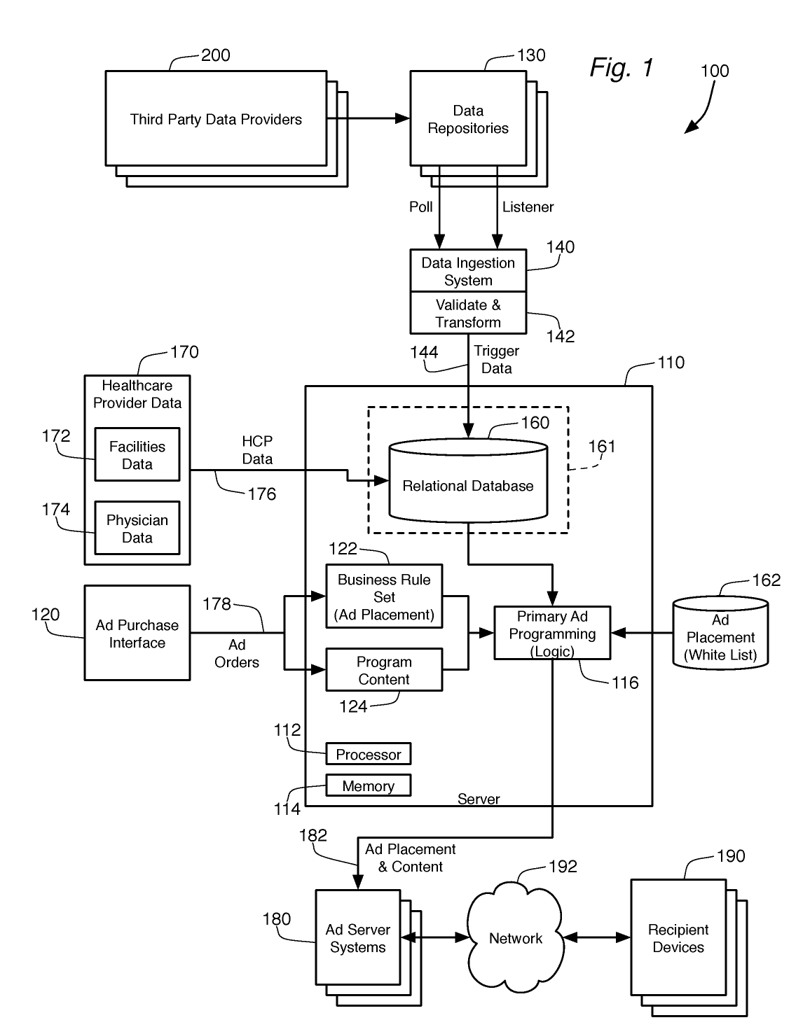

Targeted messaging and reporting system 100 is shown in FIG. 1. This system 100 is one embodiment of a system that is responsible for presenting targeted messaging in response to related, live data feeds. In at least one embodiment the system 100 is specialized for use in providing dynamic, focused messaging to identified recipients. More particularly, the messaging is directed to electronic devices that are known to be associated with identified recipients. In some embodiments, the electronic devices of recipients must further be within a geographic location predefined for each known recipient.

For the purpose of illustrating the various embodiments of the present invention, this disclosure will describe the identified recipients as physicians and other healthcare providers. In this instance, the geographic location associated with the healthcare provider can be pre-identified as an area including a specified clinic or other healthcare facility at which the healthcare provider is known to be provide services.

The server 110 of the system 100 can be considered the control system server 110, as it is primarily responsible for controlling the operation of the overall system 100. In practice, the server 110 is a computing device having a processor 112 and memory or data storage 114, and programming or logic 116. The processor 112 is preferably a general-purpose CPU such as those manufactured by Intel Corporation (Mountain View, Calif.) or Advanced Micro Devices, Inc. (Sunnyvale, Calif.). Memory 114 preferably includes a non-volatile, non-transitory, computer readable medium such as a hard drive or flash memory device. Software instructions or programming 116 can be found on the memory 114 and are used to instruct the processor 112 how to perform the methods of the present invention. To improve efficiency, the processor 112 may load software instructions from non-transitory portions of memory 114 into a faster but volatile RAM portion of the memory 114. Data operated upon by the processor 112 can also be stored in non-volatile memory and retrieved into RAM for analysis, recording, and reporting.

The fact that the server 110 is implemented as a computing device does not mean that the server 110 must exist on only a single computer system. The server can easily be implemented as multiple physical computing devices operating together to perform the functions of the control system server 110. For example, FIG. 1 shows the server 110 as incorporating the relational database 160. Although it is possible to implement the relational database 160 on the same physical computer system as the rest of the control server 110, it is frequently preferred to operate the relational database 160 on a separate, general purpose computer dedicated to the handling and manipulation of the data in database 160. This is shown schematically in FIG. 1 through a dashed box representing a separate database server 161. The rest of the control server 110 would then communicate with the database server 161 over a local network. The construction of other computing systems in the overall system 100, including the data ingestion system 140 and the message placement (or advertisement) server systems 180, is similar to the server 110 in that each device contains a processor 112, memory 114, and programming instructions similar to logic 116 that instruct the respective processors on how to perform the methods of the present invention. Furthermore, these servers 140, 180 can also be implementing using multiple computer systems operating in concert.

A general overview of the system 100 and its functions is presented in FIG. 1 in accordance with the following description:

The control system server 110 monitors and receives data, including healthcare or recipient provider data 176, from a variety of external sources collectively referred to as healthcare provider data sources 170. In addition, the control system server 110 receives trigger data 144 from a variety of third party data providers 200. Trigger data 144 and healthcare provider data 176 must be properly formatted and validated, and can then be stored by the server 110 on a relational database 160. In this case of trigger data, a special data ingestion system 140/142 is responsible for receiving the data from a plurality of data repository and then validating and transforming the data before the trigger data 144 is presented to the control system server 110.

The control system server 110 also receives advertisement orders 178 from an advertisement purchase interface 120. These orders 178 are requests made to the server 110 to send targeted messaging (which may take the form of advertisements) to a selected group of recipient devices that the system 100 is aware of via the Healthcare provider data 176. The orders 178 take the form of “programs” which include both business rules 122 for establishing when a message is to be transmitted as well as program content 124 which defines the parameters of the advertisement or message to be delivered.

The control system server 110 contains programming logic 116 that analyzes the trigger data 144 and healthcare provider data 176 to determine whether or not the business rules 122 for an order 178 have been met. If so, the recipient information (identified from the healthcare provider data 176) is analyzed to determine potential recipients of the program content 124. Potential placement locations appropriate for this message (such as websites or mobile device apps that can receive third party advertisements and messages) are identified using the ad placement information 162. This information 162 can take the form of a “white list” of acceptable locations. Finally, advertisement content and placement instruction information 82 is then delivered via the message placement/advertisement server systems 180. These systems are specially programmed to identify potential opportunities to present message on recipient devices 190. Information about these opportunities may be identified by a third-party message/ad placement service, which identifies messaging opportunities and puts those opportunities up for bit. The advertisement server system 180 analyzes those opportunities, bids on relevant opportunities, and then causes the program content/message to appear on the identified individual recipient devices 190.

The individual sub-systems, and the mechanisms that make the focused, triggered delivery of advertisements by the system 100 possible are discussed in greater detail below.

Turning first to the source of the underlying healthcare provider data 176, the healthcare provider data source 170 is a collection of wide ranging and diverse data provided from both proprietary and third party data providers. The healthcare provider data 176 can be visualized as being focused on facilities data 172 and individual physicians or practitioner data 174; the latter of which is typically associated with one or more of the facilities described by the facility data 172.

Facilities data 172 includes a variety of data points not limited to medical facility location, staffing data, patient population data, medical specialty of the facility, and or other data that may be used to identify specific attributes, conditions or even trends that may have occurred or be occurring at a medical facility. The facilities location can be specified as a physical mailing address, which can be converted into a more useable GPS coordinate or latitude/longitude pairs using well-known conversion data sources. In other instances, location information is subdivided into small, numerically defined regions using well-known location handling processes.

Physician data 174 includes identifying information for the healthcare providers, such as name, age, medical specialty, specific area of practice, medical school, and affiliations. It is noted that the term “physician data” is merely a descriptor and may include any individuals, physicians or otherwise, that may be relevant to a targeted advertisement order 178. This data also includes information about each individual's personal electronics such that actions performed using those electronics can be associated with that individual. Such information may include the device's internet protocol address (for stationary devices), device identifier, MAC address, or any other identifier that may be used to identify a device. In the preferred embodiment, a single individual in data 174 may be associated with multiple devices, with each device being identified in data 174 using different identifier data. The various data points provided by the healthcare provider data sources 170 supply system 110 and advertisement server systems 180 with sufficient information to create target specific devices of individuals based on the parameters of the advertisement order 178.

Part of the analysis which the control server 110 engages in to identify the proper recipient devices is based on the business rule set 122, which is received as part of the message order 178 from the advertisement purchase interface 120. A customer may request an advertisement from an advertisement purchase interface 120. The advertisement order 178 may include the requirement that the requested advertisement be sent to a group of recipient devices 190 that are identified via the healthcare provider data source 170 as being physicians of a particular medical specialty (as described by physician data 174). Furthermore, the set of physicians to receive the message is limited to those that are practicing at a specific facility (as provided by facilities data 172) where some physician in that facility has recently written a prescription to a patient of a specific pharmaceutical. The advertisement order 178 may include a rule set 122 that identifies the advertising content 124, identifies the triggering pharmaceuticals that will cause the advertisements to be displayers, identify the medical specialty involved, and require that the advertisements appear only when the healthcare provider is present at the facility where the prescription was written. The rule set 122 may even limit the message so that it is displayed only when a device associated with a healthcare provider is being used to view any one of a plurality of pre-selected websites.

In the above example the primary advertisement programming 116 cannot send out the advertisement content 182, nor make the final determination of the properly identified recipient devices 190 until the control system server 110 first receives trigger data 144 from any of a variety of third party data providers 200. This data is provided continuously by the providers 200 through using a particular technical solution. Prior art systems have required that data providers provide their data directly to the control server system 110, which would typically require that each data provider 200 format and present their data in the manner required by the control system 110.

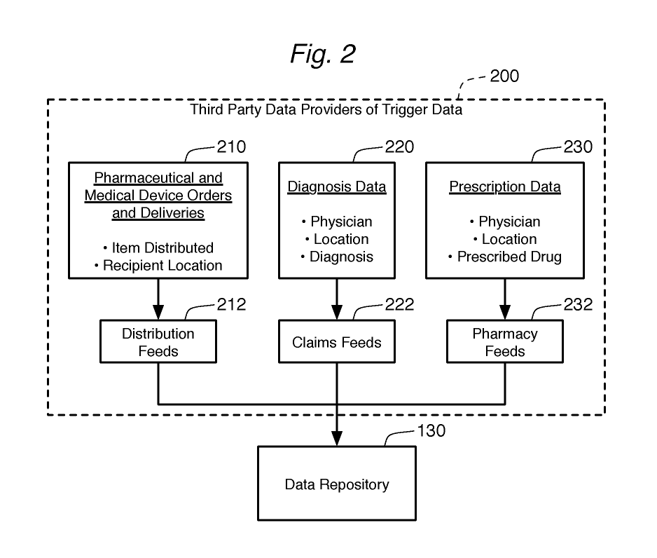

Instead of using this traditional approach, the system 100 monitors a variety of data repositories 130 for data that has been placed on those repositories 130 provided by various third party providers 200. The data is submitted to the repository in the manner and format that best serves the needs of the data provider 200. In some cases, the repository 130 is owned and controlled by the data provider itself, while in other cases the repository 130 is under the same ownership and control as the control server 110. In situations where the repository 130 is owned by the data provider 200, it may not be possible to place additional programming on the repository 130 in order to transmit the received data to the rest of the system 100. In these cases, the system 100 will poll or query the repositories for various classes or types of data on a timed or programmed basis. The system 100 can then analyze the repository 130 for changed or updated data, and then pull the new data from the repository 130. If the repository 130 is under the control of the owner of the control system serer 110, a listener application or similar programming device can be installed and configured to listen or constantly monitor repositories 130 for the desired data. When this programming determines that new data is present, the listener will push that data to the rest of the system 100. Selected data points collected in this manner will eventually become trigger data 144 and may include data types such as are shown in the embodiment illustrated in FIG. 2.

Such data types may include pharmaceutical and/or medical device orders and deliveries 210, diagnosis data 220, prescription data 230, etc. The orders data 210 relates to the distribution of items such as drugs and devices, and therefore results in the creation of a “distribution” feed of data 212. This information may include the item, device, or pharmaceutical delivered, quantity of the deliver, the delivery time and date, the order time and date, the recipient location, etc. The diagnosis data relates to a diagnosis made by a physician of a patient, and may include the name of the physician making the diagnosis, the location of the facility where the diagnosis was made, and the actual diagnosis involved. This “claims” data may stem from insurance claim information or even from other health records, although any and all personally identifying information is stripped from this data before it is shared and place on the repositories 130 as a claims feed 122. The prescription data 230 include information about a particular prescription made by a physician, and therefore includes identifying information about the physician, the prescribed drug or treatment, the location of the facility where the prescription was made, and in some cases the location where the prescription was filled. Again, all personally identifying information about the patient is stripped from this data before it becomes a pharmacy feed 232 and placed on one of the data repositories 130. In at least one embodiment diagnosis data 220 is based on International Statistical Classification of Diseases and Related Health Problems (ICD10) designation, which is provided by a diagnosing healthcare provider.

Another technical improvement for receiving this data from the repositories 130 relates to the use of the data ingestion system 140. Each of these data feeds are accessed by and transported into or ingested by the data ingestion system 140 before being presented to the control system server 110. The data ingestion system 140 may be configured and function in variety of ways. In at least one embodiment, the system 140 includes a client owned mechanism which simply queries the data repositories 130 at set intervals, i.e. polling. Such a client owned system may utilize a secure file transfer protocol daemon and/or a Simple Storage Service (S3). In another embodiment, the ingestion system 140 is proprietary and can utilize polling or may be event driven. This second embodiment is primarily used when the same party that controls the control system server 110 controls the repository 130 containing the data.

Once the data from the data repository 130 has been ingested into the data ingestion system 140, the data must be verified and converted into a standard protocol that the control system server 110 can utilize via the validate and transform programming 142 in FIG. 1. In this step, the data is first checked to be a valid form or text file and that its format is command separated, tab separated or pipe separated. The validation process will weed out blank records and other missing data elements. The ingestion system 140 then transforms the data by converting the data format received from the data provider 200 and found on the repository 130 into the appropriate format for the data that is expected by the control server system 110. The resulting transformed and validated data is referred to as trigger data 144, which is receiving and recognized by the server 110 and sent to the relational database 160.

Returning to and continuing with the functional example started above: when the control system server 110 receives via polling or listening, trigger data 144, which may be for example a prescription order derived from prescription data 230 describing an order for a drug to be prescribed by a physician, the server 110 will compare that trigger data 144 with the requirements of its current advertisement orders 178. More particularly, this data is compared with all the business rules 122 for its active orders 178. One such rule may request that an advertisement for a drug (that competes with the drug listed on the prescription order), be sent to the device of a physician (known via the physician data source 174) who prescribes a drug that is in commercial competition to the ordered drug. When the prescription data for that competing drug is received, it matches the business rule 122 for that ad order and acts as a trigger to cause that advertisement to be sent to the device of that physician. Other business rules 122 may specify that a competing drug prescription trigger the ad for all healthcare providers that work at the same facility where the prescription originated. The business rules may further specify that the ad is to be presented only when the healthcare providers are on-site at that facility. In at least one embodiment of the invention, the system 100 is configured to deliver advertisement content 182 within 24 hours of receiving relevant trigger data 144.

### Method

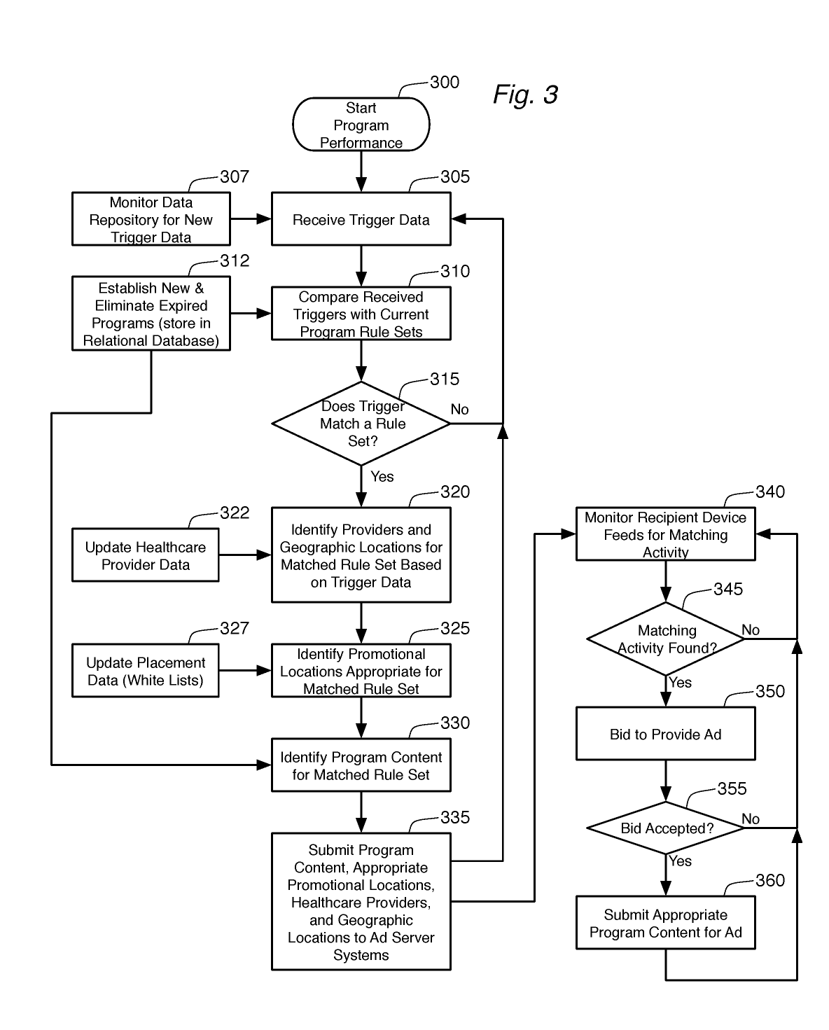

A step-by-step summary of this functionality of the system 100 is provided in FIG. 3 with descriptive reference made to the elements of the system 100 shown in FIGS. 1 and 2 as follows:

The initiation of the program performance is initiated at block 300.

At block 305, the system 100 receives new trigger data 144 via the data ingestion system 140. As explained above, this data 144 will transformed into an appropriate format, validated and saved onto the relational database 160. Block 307 shows that this data is shared with the control system server 110 by the data ingestion server 140, monitors the data repositories 130 and/or queries the repositories 130 for new trigger data 144 to be shared with the control server system 110.

At block 310 the primary advertisement programming compares the received trigger data against the business rule set 122 of the advertisement order 178. Block 312 indicates that these business rules 122 formed part of an advertisement order 178 that is received by the server 110 via the advertisement purchase interface 120. The business rule set 122 of the order 178 is reviewed by the primary advertisement programming 116 and compared with incoming trigger data 144 to determine if any messaging orders 178 have been triggered. Block 312 also indicates that these orders 178 may have a limited lifespan, so as new orders 178 are added to the system 100 old orders expire and may be removed from the system 100.

At block 315 the server 110 compares the relevant trigger data 144 against the rule set 122 to determine if a match or overlap in parameters exists. If no match is found, then the received trigger data 305 does not match any rules 122 for an active messaging program. As a result, processing is returned to bock 305 to await the receipt of new trigger data. If a match is found the system proceeds to block 320.

At block 320 the control system server 110 queries the HSP data 176 to identify healthcare providers, their locations and/or individuals based on the matched rule set established at block 315. For instance, the rule set 122 may indicate that a particular order 178 wants to share ads with all healthcare providers at facilities where a prescription for a competing pharmaceutical was written. Block 320 is responsible for querying data 176 to identify the physician described in the trigger data 144 within the physician data 174, identify the facility associated with that physician in data 172, identify all healthcare providers that work at that facility in data 174, filter the identified healthcare providers to a particular specialty relevant to the prescription, and then identify all devices associated with the filtered list of healthcare providers. Block 322 illustrates the system's function of maintaining and updating healthcare provider data 176 as provided by the source 170. This data is reviewed and associated via block 320.

At block 325, the system 100 then identifies virtual locations received from the ad placement database 162 (shown as block 327) that is appropriate for receiving the advertising messages. For example, this data 162 may contain a list of acceptable or recognized locations according to a “white list” or other filter mechanism.

At block 330 the program content 124 of the advertisement order 178 is identified in accordance with the matched rule set 122. In most cases, the rule set 122 may specify which particular ad or program content 124 is to be presented in different situations. The ad content 124 may be of different dimensions and therefore the choice of ad content may be a simple manner of matching the space made available for messages in the user interface of the recipient devices 190. In other circumstances, the rule set 122 may specify that different content 124 is presented to different sets of healthcare providers. In any case, the method of FIG. 3 allows the rule set 122 to determine which content or contents will be presented to the identified devices.

At block 335 the program content 124, appropriate promotional locations, healthcare provider information (including device identifiers) and geographic location limitations are submitted to the advertisement server 180 for distribution of the messaging. Once the system 100 has sent out the advertisement placement and content 182 to the advertisement server system 180, the advertisement server system 180 then monitors potential advertisement placement opportunities among the recipient devices 190 operating over a wide area network 192. It does so by monitoring fees from advertisement coordinators (such as Google) at block 340. At block 345 the advertisement server system 180 compares the placement opportunities against the data received from the control server 110 in real time. If no match is found (the monitored devices that are looking for messages do not match the devices specified by the control server 110 in step 335), the method returns to block 340 to await additional opportunities.

At block 350, if a match is found (a matching device is looking for a message that matches all the criteria specified at step 335), an aggressive bid price is submitted for the placement of the message on the recipient device(s) 190. The bid is aggressive to ensure that the opportunity is not lost to a competing advertisement server that is also looking to place messages on the recipient devices. Because of the highly targeted nature of the messages provided in system 100, the revenue potential per message is higher than traditional advertisements/messages, and therefore a relatively high bid can be submitted to secure this placement in step 350.

At block 355 if the bid is accepted, the message content is presented on the recipient device 190 at block 360. If the bid is not accepted then the program returns to block 340.

### Report Generation

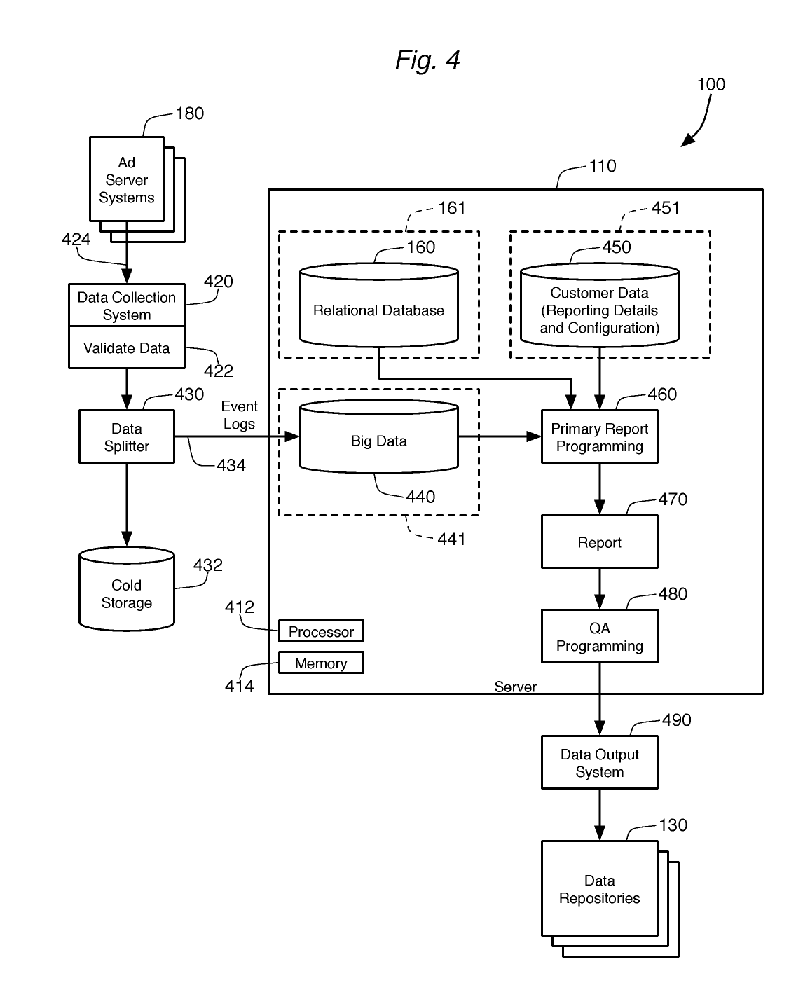

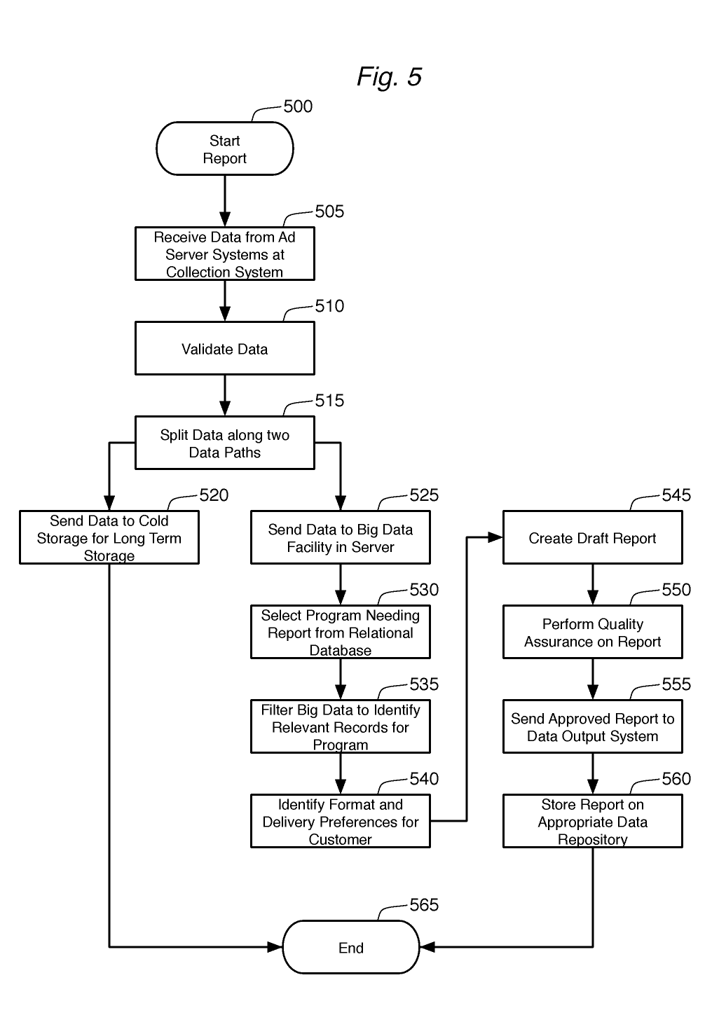

As part of the advertising ordering and distribution process described above, the system 100 is also configured to provide reports regarding advertisement delivery and other performance criteria to those utilizing the system 100. The reporting aspect of the system 100 as well as its capacity to provide long term storage of the data utilized by the system is depicted in FIG. 4, and a method for performing the reporting process is put forth in FIG. 5. The reporting aspect of the system 100 may be contained within and an inherent part of the central control server 110 or may be a separate server system in communication therewith.

Turning now to FIG. 4, an embodiment system 100 of the invention is illustrated which focuses on the manner in which a messaging or advertisement server system 110 provides various log files (logs) that are a consequence of the advertisement server system's interfacing with the network and recipient devices as previously described and illustrated in FIGS. 1 and 3.

The logs are a record of millions of data points related to the delivery of the messages/advertisements to recipient devices 190. Each data point in the log can contain a variety of data, such as the program content 124 shared, information identifying the recipient devices 190 (physical location, ID information, etc.), timing information of the impression (advertisement being sent and delivered to the recipient device), price paid for the impression event, the result of the impression (did the recipient interact with the message such as by “clicking-through” the message for more information), etc. In at least one embodiment, the data in the advertisement server system 180 logs contained at least 115 different types of data elements.

In order to collect and use the log information the system 100 includes a data collection system 420 that receives the logs 424 from the advertisement server system 180. When received from the advertisement server system 180, the log files 424 comprise hundreds of millions to billions of rows of data per day. In order to properly organize this volume of data and ensure that each file is properly formatted and uncorrupted, the data collection system 420 includes a validation mechanism 422 that processes each log file and provides it with a validation signature.

Once validated, the logs are then copied/split by a data splitter 430 or other program, with one copy of the files recorded in a long term or “cold” storage facility 432 wherein any and all of the log information may be accessed and reviewed at a later time, and a second copy of the validated log files—now identified as event logs 434—being sent to the Big Data system 440.

The Big Data system 440 may be a cloud-based, hosted, or onsite system. In at least one embodiment, Big Data system 440 is provided by Amazon Redshift. Other data warehousing products and system may also be utilized to provide Big Data system 440, such as for example Teradata Data Warehouse Appliance or any other data warehousing system that may be readily accessed and which supports the processing of millions to billions of processes per day. The Big Data system 440 is designed to allow the event log data to be accessed, filtered, and otherwise utilized by the control server system 110 to provide reports as desired.

The Big Data system 440 is shown as forming part of server 110. As was explained in connection with database 160 and the potential use of a separate database server 161, it is not necessary that the Big Data system 440 be integrated into the server 110, and in fact the preferred embodiment actually uses multiple, separate computer systems operating in cooperation as the Big Data system 440. This use of separate computing systems is represented in FIG. 4 through dashed-line box 441.

A report 470 may be triggered by a manual request, by pre-programmed schedule or by any other trigger mechanism desired. When a report request is triggered, a query is sent to the relational database 160, which provides the details about which data is to be provided in the report, including specific data fields, headings, groupings, output styles, and filters (such as filters to identify data relating to a specific advertisement order 178 or a specific time range for the report being delivered). The primary report programming 460 then queries the Big Data system 440 to obtain the requested data from the event logs 434.

Customers may also submit to the system 100 their own data requirements, delivery options, and other configuration requirements. For example, a customer may wish all report data to be formatted in a particular format, or to be delivered by depositing the data on a particular data repository 130. This information can be stored on a separate customer database 450. This database 450 is queried by the primary report programming 460 along with the relational database 160 to ensure that the generated report is in a desired format. In some embodiments, the data in these two databases 160, 450 will be merged into a single relational database. Furthermore, this database 450 could also be operated on a separate database server system 451.

Once all the queries have been made, the primary report programming 460 will create the report 470 with the received data and formatting options. The report 470 is then analyzed by a quality assurance (QA) program 480, which may include automated scripts as well as human review and procedures. The QA programming 460 insures that the data within the report 470 is both correct and in the proper format.

Once the report is verified as being correct by the QA program 480, the server 110 sends out the report via a data output system 490. The data output system 490 is preferably a separate computer system like data collection system 420 and data ingestion system. The data output system 490 is configured to receive reports from the server 110 and push text reports out to the right locations including the various data repositories 130 (see FIG. 1) where clients request that their data be sent. In some embodiments, the clients may also be third party data providers 200, in which case the data repository 130 that receives the report data may be the same repository 130 used to receive data from the third-party data providers 200. The data output system 490 records the name of the file being sent, the time it was sent, as well as signatory or other verification information associated with the report. If desired by the client to whom the report is being sent, the system 490 may be configured to send a trigger notification to the client notifying them that the report has been sent.

A summary of the method of creating a report, in accordance with system shown in FIG. 4, is provided in FIG. 5 and in the following description:

At block 500, a request for a report by schedule or manual requests initiates the report creation function. At block 505, the data collection system 420 receives log data 424 from the advertisement server system 180. This system then validates the log information at block 510. At block 515, the log data is copied and split with one set of log data being transferred to “cold” storage 432, at block 520, and the event log set 434 being transferred to the Big Data system 440 at block 525.

At block 530, the primary report programming 460 queries the relational database 160 for initial report information. At block 535, the primary report programming 460 filters the event log data within the Big Data system 535 for data records relevant to the report. At block 440, the primary report programming 460 accesses the customer preference database 450 to identify formatting and delivery preferences of the customer.

At block 545, the data for the report is assembled in the desired format and prepared as an initial report 470. At block 550, the report 470 is reviewed by the QA programming for approval 480. At block 555 the data output system 490 send the report out to the locations 130 instructed by the system and/or customer. At block 560 the report 470 is stored on the appropriate data repository 130. Block 565 ends the process.

As the above description makes clear the present system 100 has a wide variety of capabilities. While a primary function is to allow a customer to order and place advertisements in a focused manner on specific recipient devices in accordance with specific triggering events; the present system also provides the customer as well as third party vendors with the data analytics tools including the creation of reports to see precisely how the system is benefiting them and how their ordered advertising campaigns are performing.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A system for providing targeted messaging comprising:
a control system server, the control system server containing message programming and a relational database;
a plurality of data repositories containing trigger data received from data repositories, each of the data repositories providing a plurality of trigger data items to the relational database;
a recipient data source, the recipient data source providing recipient data to the message programming, the recipient data identifying a plurality of recipients and a recipient device identifier for each recipient;
a message purchase interface, the message purchase interface configured to provide the control system server with a messaging program including business rules and message content;
the message programming configured to:
determine that a first trigger data item meets the business rules of the message program,
use the business rules to identify a first subset of recipients to receive the message content.
submit message content and first subset of recipients to message server system.

2. The system of claim 1, wherein the recipient data is healthcare provider data and the plurality of recipients are healthcare providers.

3. The system of claim 2, wherein the healthcare provider data includes data describing healthcare facilities.

4. The system of claim 3, wherein a first subset of recipients is identified by first identifying a healthcare facility from within the data describing the healthcare facilities and based on the business rules and the trigger data, then identifying healthcare providers working at the healthcare facility.

5. The system of claim 4, wherein the business rules include a geographic location limitation.

6. The system of claim 5, wherein the geographic location limitation is determined by geographic location of the facility as identified in the healthcare data.

7. The system of claim 1, further comprising a data ingestion system, the plurality of trigger data items being retrieved from the plurality of data repositories by the data ingestion system.

8. The system of claim 7, wherein at least one of the plurality of data repositories is polled for the presence of the plurality of trigger data items by the data ingestion system.

9. The system of claim 7 wherein at least one of the plurality of a data repositories include a listening application, the listening application configured to listen for the plurality of trigger data items and when at least one of the plurality of trigger data items is detected to send the detected trigger data item to the data ingestion system.

10. The system of claim 9 wherein the plurality of data repositories includes repositories of trigger data selected from at least one of pharmaceutical orders, medical device orders, diagnosis data, prescription data, insurance claim information and any combination thereof.

11. The system of claim 7 where in the data ingestion system includes a data transformation and validation application, the data transformation and validation application is configured to transform the plurality of trigger data items received from the plurality of data repositories into a uniform and recognizable format that is validated for input into the relational database.

12. The system of claim 1, further comprising an advertisement white list of acceptable recipient device locations, the advertisement white list in communication with the control system server wherein the message programming is further configured to submit acceptable recipient device locations to the message server system along with the message content and first subset of recipients.

13. The system of claim 12, wherein the message server system is configured to transmit the message content to the recipient devices having the recipient device identifier provided by the recipient data source.

14. The system of claim 13, wherein message server system creates log files for each communication with the recipient devices.

15. The system of claim 14 wherein the log files are transmitted from the message server system to a data collection and validation system, the data collection and validation system converting all of the log files into a single format of validated event logs.

16. The system of claim 15 wherein the event logs are recorded and split by a data splitter, with one set of event logs sent to a cold storage database and a set sent to a big data system.

17. The system of claim 16, further comprising a primary report programming within the control system server, the primary report programming is in communication with the relational database, and the big data system, the primary report programming configured to provide a report by collecting the event logs stored in the big data system associated with the messaging program and formatting the event logs into a report appropriate for the messaging program.

18. The system of claim 17, further comprising a quality assurance program, the quality assurance program is configured to verify that any data within the report is correct, once verified as correct the control system server sends the report to a data output system, the data output system is in communication with the plurality of data repositories.

19. A method for providing targeted messaging to at least one digital device digital of at least one healthcare provider comprising:
providing a system having a control system server, the control system server containing message programming and a relational database;
receiving trigger data at the relational database, the trigger data selected from a set of data types comprising pharmaceutical orders, medical device orders, diagnosis data, and prescription data, insurance claim information and any combination thereof;
receiving recipient data at the relational database from a recipient data source, the recipient data source providing recipient data to the message programming, the recipient data identifying a plurality of recipients and a recipient device identifier for each recipient;
providing a message purchase interface, the message purchase interface configured to provide the control system server with an ordered messaging program including business rules and message content
receiving at the control system server an ordered message program;
determining that a first trigger data item meets the business rules of the ordered message program
using the business rules to identify a first subset of recipients to receive the ordered message content; and
submitting the ordered message content and first subset of recipients to a message server system;
transmitting from the message server system the ordered message content to the at least one digital device of at least one healthcare provider.

20. A method comprising:
a) receiving trigger data at a relational database, the trigger data selected from a set of data types comprising pharmaceutical orders, medical device orders, diagnosis data, and prescription data, insurance claim information and any combination thereof;
b) comparing the trigger data to business rules associated with message programs to find a triggered message program;
c) identifying a class of recipients based on the triggered message program;
d) identifying a healthcare facility based on the class of recipients and the trigger data;
e) identifying a geographic location for the healthcare facility;
f) identifying healthcare providers associated with the healthcare facility;
g) identifying digital devices associated with the set of healthcare providers;
h) identifying messaging appropriate for the recent transactional information;
i) transmitting the identified messaging to the identified digital devices when the digital devices are proximal to the geographic location for the identified healthcare provider facility.
